(19) United States
(12) Patent Application Publication
(10) Pub. No.: US 2014/0024790 A1
(43) Pub. Date: Jan. 23, 2014

(54) MULTINUCLEAR METALLOCENE CATALYST COMPLEXES FOR OLEFIN POLYMERISATION AND COPOLYMERISATION AND METHOD OF PREPARING THEREOF

(71) Applicants: Haif Al-Shammari, Riyadh (SA); Helmut Alt, Bayreuth (DE)

(72) Inventors: Haif Al-Shammari, Riyadh (SA); Helmut Alt, Bayreuth (DE)

(21) Appl. No.: 14/002,910

(22) PCT Filed: Feb. 14, 2012
(86) PCT No.: PCT/EP12/00639

§ 371 Date: Sep. 3, 2013

(30) Foreign Application Priority Data
Feb. 18, 2011 (EP) 11001336.4

(51) Int. Cl. C08F 110/02

(52) U.S. Cl. CPC C08F 110/02
USPC 526/170; 502/103; 502/117; 556/52

(57) ABSTRACT

The invention relates to a multinuclear metallocene catalyst of general formula (1); wherein Y and Y′ are the same or different and independently selected from a C₁₋₂₀ linear hydrocarbyl group; C₁₋₂₀ branched hydrocarbyl group; C₁₋₂₀ cyclic hydrocarbyl group; a C₁₋₃₀ aryl group and a C₁₋₃₀ substituted aryl group; L and L′ are the same or different and each is an electron-donating group independently selected from the elements of Group 15 of the Periodic Table; Q and Q′ are the same or different and independently selected from hydrogen, a C₁₋₃₀ alkyl group and a C₁₋₃₀ aryl group; M″ is a metal selected from Group 3, 4, 5, 6, 7, 8, 9 and 10 elements and from lanthanide series elements of the Periodic Table; Z is selected from the group consisting of hydrogen; a halogen element; a C₁₋₂₀ hydrocarbyl group; C₁₋₂₀ alkoxy group and a C₁₋₂₀ aryloxy group; B and B′ are the same or different and each is a half sandwich metallocene compound, with B being represented by Formula 2 and B′ being represented by Formula 3: W-M-Xₓ (Formula 2), W′-M′-X′_{x′}, (Formula 3) wherein: W and W′ are the same or different and independently a ligand compound having a cyclo pentadienyl skeleton selected from the group consisting of cyclopentadienyl, substituted cyclopentadienyl, indenyl, substituted indenyl, fluorenyl and substituted fluorenyl; M and M′ are the same and each is independently selected from the group consisting of scandium; yttrium; lanthanoid series elements; titanium; zirconium; hafnium; vanadium; niobium; and tantalum; X and X′ are the same or different and each is selected from the group consisting of hydrogen; a halogen element; a C 1-20 hydrocarbyl group, C₁₋₂₀ alkoxy group; and C₁₋₂₀ aryloxy group; x and x′ are independently integers from 0 to 3; z is an integer from 1 to 5; n, n′ are independently 0 or 1, with 1≦(n+n′)≦2. The invention further relates to a method to prepare said multinuclear metallocene catalyst compound. The invention further relates to a catalyst system and to a process for the polymerisation of olefins.

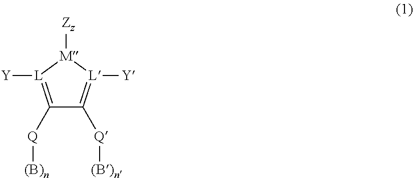

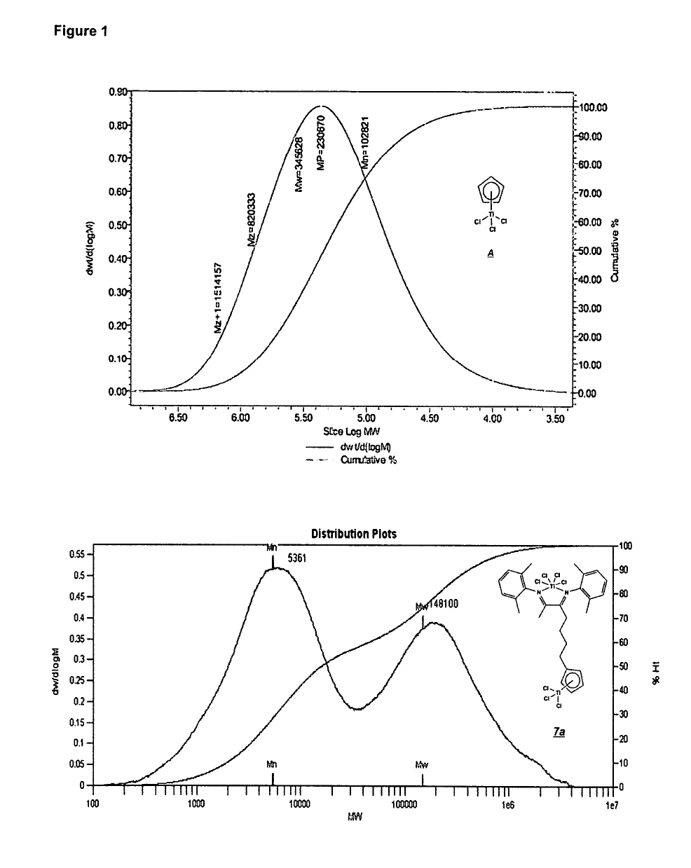

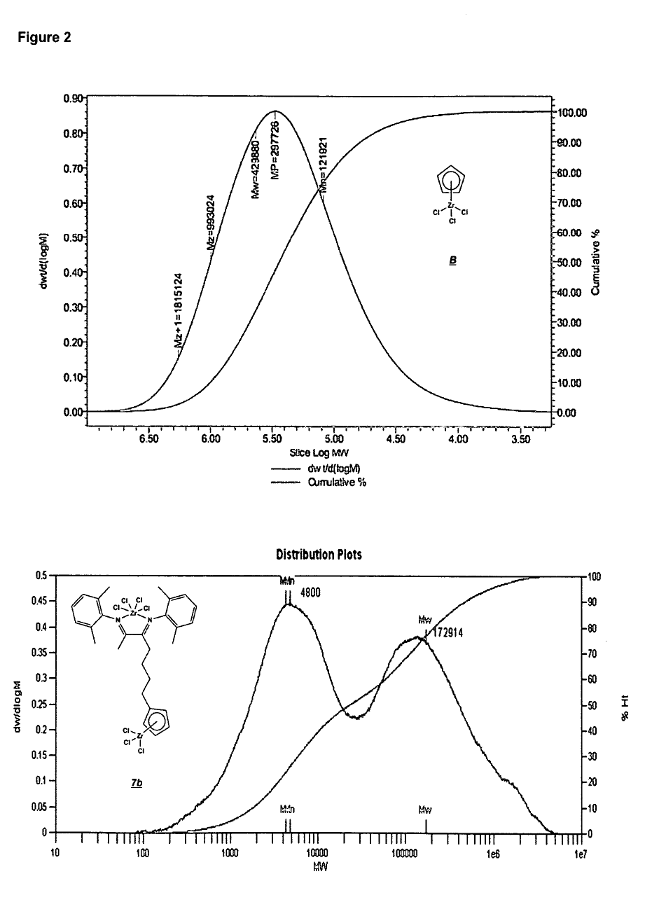

### CROSS REFERENCE TO RELATED APPLICATIONS

This application is a 371 of International Application No. PCT/EP2012/000639, filed Feb. 14, 2012, which claims priority to European Application No. 11001336.4, filed Feb. 18, 2011, both of which are hereby incorporated by reference in its entirety.

The present invention relates to a multinuclear metallocene catalyst compound for polymerisation and/or copolymerisation of olefins. The present invention also relates to a method to prepare said metallocene catalyst compound and to a catalyst system comprising said multinuclear metallocene catalyst compound. The present invention further relates to a process for polymerisation and/or copolymerisation of olefins in the presence of said multinuclear metallocene catalyst system.

It is generally known that the molecular weight distribution (MWD) influences the properties of polyolefins and as such influences the end-uses of a polymer. There is a requirement for polyolefins with broad molecular weight distribution as broad MWD tends to improve the flowability at high shear rate during the processing. Thus, broadening the MWD is a way to generally improve the processing of polyolefins in applications requiring fast processing at fairly high die swell, such as in blowing and extrusion techniques. A multimodal MWD polymer is defined as a polymer having at least two distinct molecular weight distribution curves as observed from gel permeation chromatography (GPC). For example, a polymer with bimodal molecular weight distribution is based on a first polymer with relatively higher molecular weight distribution and a second polymer with a relatively lower molecular weight distribution that are blended together.

Various approaches to produce polyolefins having broad and multimodal molecular weight distribution are already known in the prior art. For instance, Knuutila et al. (Adv. Pol. Sci. 2004, 169, 21-24) gives an overview of several methods of producing polyolefins, particularly polyethylene having a broad and multimodal MWD. Polyethylene having a multimodal MWD can be made by employing two distinct and separate catalysts in the same reactor each producing a polyethylene having a different MWD; however, catalyst feed rate is difficult to control and the polymer particles produced are not uniform in size and density, thus, segregation of the polymer during storage and transfer can produce non-homogeneous products. A polyethylene having a bimodal MWD can also be produced by sequential polymerization in two separate reactors or blending polymers of different MWD during processing; however, both of these methods increase capital cost.

It is also known that polymers having broad molecular weight distribution can be obtained by using multinuclear metallocene catalyst compounds in olefin polymerisation. For example, document WO2004/076402A1 discloses a supported multinuclear metallocene catalyst system having at least three active sites and comprising a dinuclear metallocene catalyst, a mononuclear metallocene catalyst and an activator. This system involves using a support and two distinct and separate catalysts in the same reactor to obtain polyethylene, which is costly and generally results in non-homogeneous products. Polyolefins with a molecular weight distribution (MWD) of at most about 10 were produced.

U.S. Pat. No. 6,380,311B1 discloses a process for the preparation of polyolefins having a bi- or multimodal molecular weight distribution by mixing polymers of different MWD obtained in two different reactors in series, in the presence of a bimetallic metallocene catalyst system. MWD of at most about 17 are obtained.

C. Görl and H. G. Alt (J. Organomet. Chem. 2007, 692, 5727-5753) describe the synthesis of multinuclear complexes containing combined ligand frameworks, particularly combined metallocene complex fragments and phenoxyimine moieties by applying zirconium as metal centre, which is then coordinated in different ligand spheres, in order to produce polyethylenes with bimodal or broad molecular weight distribution. The synthesis of such catalyst complexes is rather complex and the catalyst shows relatively low activity in olefin polymerisation.

Feng Lin et al. (J. Appl. Polym. Sci. 2006, vol. 101, 2217-3326) disclose alkylidene bridged asymmetric dinuclear titanocene catalyst compound for ethylene polymerisation. The polyethylene obtained by using these compounds has a MWD of at most about 8 and low activity of the catalysts was observed.

H. Alt et al. (J. Mol. Cat. A: Chem. 2003, vol. 191, 177-185) disclose mono-, di- and tetranuclear ansa zirconocene complexes as catalysts for ethylene polymerisation. The MWD for the obtained polyethylene in the presence of these catalysts complexes was not higher than 6; in addition low catalyst activities and yields were attained.

M. Schilling et al. (J. Appl. Polym. Sci. 2008, vol. 109, 3344-3354) disclose dinuclear silicon bridged zirconium complexes used in producing polyethylenes. These catalysts are supported on micro-gels. Although broad MWD is obtained for a polyethylene produced by employing such catalysts, the activities measured for these catalyst systems were rather low. M. Schilling et al. (Polym. 2007, vol. 48, 7461-7475) also disclose a more complex metallocene catalyst system prepared by applying fumed silica and mesoporous support materials, zirconocene dichloride, titanocene dichloride and a bis(arylimino)pyridine iron complex as catalyst compounds. The ternary Zr/Ti/Fe catalyst mixtures produced polyolefins with a MWD of at most about 35 and rather low catalyst activities; the binary systems produced polyolefins with a MWD of at most about 5. Generally, the use of a support in preparing metallocene-based catalyst compounds renders the synthesis of such catalyst systems more tedious, time consuming and costly.

H. Alt et al. (Inorganica Chimica Acta 2003, 350, 1-11) disclose asymmetric dinuclear ansa zirconocene complexes with methyl and phenyl substituted bridging silicon atoms as dual site catalysts for the polymerisation of ethylene. Homogeneous and heterogeneous catalysts were used for ethylene polymerisation. Narrow molecular weight distributions, low catalyst activities and low yields are obtained by applying both catalyst systems.

An object of the present invention is to provide a metallocene-based catalyst compound for polymerisation of olefins that overcomes at least part of the disadvantages of the prior art. More in particular it is an object of the present invention to provide a catalyst compound that compared to other multinuclear metallocene catalysts shows higher catalytic activity, which is obtained with higher yields and produces polyolefins having a broader, multimodal molecular weight distribution.

At least one of these objects is achieved according to the present invention with a multinuclear metallocene catalyst compound according to Formula 1:

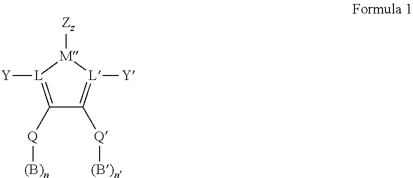

wherein:

Y and Y′ are the same or different and independently selected from a C₁₋₂₀ linear hydrocarbyl group; C₁₋₂₀ branched hydrocarbyl group; C₁₋₂₀ cyclic hydrocarbyl group; a C₁₋₃₀ aryl group and a C₁₋₃₀ substituted aryl group;

L and L′ are the same or different and each is an electron-donating group independently selected from the elements of Group 15 of the Periodic Table;

Q and Q′ are the same or different and independently selected from hydrogen, a C₁₋₃₀ alkyl group and a C₁₋₃₀ aryl group;

M″ is a metal selected from Group 3, 4, 5, 6, 7, 8, 9 and 10 elements and from lanthanide series elements of the Periodic Table;

Z is selected from the group consisting of hydrogen; a halogen element; a C₁₋₂₀ hydrocarbyl group; C₁₋₂₀ alkoxy group and a C₁₋₂₀ aryloxy group;

B and B′ are the same or different and each is a half sandwich metallocene compound, with B being represented by Formula 2 and B′ being represented by Formula 3:

W-M-Xₓ (Formula 2)

W′-M′-X′_{x′} (Formula 3)

wherein:

W and W′ are the same or different and independently a ligand compound having a cyclopentadienyl skeleton selected from the group consisting of cyclopentadienyl, substituted cyclopentadienyl, indenyl, substituted indenyl, fluorenyl and substituted fluorenyl;

M and M′ are the same and each is independently selected from the group consisting of scandium, yttrium, lanthanoid series elements, titanium, zirconium, hafnium, vanadium, niobium, and tantalum.

X and X′ are the same or different and each is selected from the group consisting of hydrogen; a halogen element; a C₁₋₂₀ hydrocarbyl group, C₁₋₂₀ alkoxy group; and C₁₋₂₀ aryloxy group;

x and x′ are independently integers from 0 to 3;

z is an integer from 1 to 5;

n, n′ are independently 0 or 1, with 1≦(n+n′)≦2.

The skilled person will understand that if Q is hydrogen n will be 0. Likewise if Q′ is hydrogen, n′ will be 0. In addition the skilled person will understand that Q and Q′ cannot both be hydrogen in view of the requirement that 1≦(n+n′)≦2. Finally the skilled person will understand that if n++n′=2 neither Q nor Q′ can be hydrogen.

In an embodiment Q and Q′ are the same or different and independently selected from a C₁₋₃₀ alkyl group and a C₁₋₃₀ aryl group.

Among the additional advantages of the present invention are that the catalyst can be manufactured in a simple manner and at low cost. Also, the catalyst components are easy to separate and show good stability during the purification process.

Preferably, Y and Y′ are the same and each is selected from the group consisting of a C₁₋₂₀ linear hydrocarbyl group, a C₁₋₂₀ cyclic hydrocarbyl group, a C₁₋₃₀ aryl group and a substituted C₁₋₃₀ aryl group. More preferably, Y and Y′ are independently selected from C₁₋₃₀ aryl and C₁₋₃₀ substituted aryl groups. Even more preferably, Y and Y′ are the same and independently selected from C₁₋₁₅ substituted aryl groups. Most preferably, Y and Y′ are the same and selected from the group consisting of methyl benzene, isopropyl benzene and ethyl benzene.

Preferably, L and L′ are the same and each is an electron-donating group independently selected from the elements of Group 15 of the Periodic Table. More preferably, L and L′ is each a nitrogen atom.

Preferably, Q and Q′ are the same and each is a C₁₋₃₀ alkyl group or a C₁₋₃₀ aryl group; and more preferably Q and Q′ is each a C₁₋₃₀ alkyl group. Even more preferably, Q and Q′ are the same and each is selected from a methyl, ethyl, propyl, butyl, pentyl and a benzyl group. Most preferably, Q and Q′ is each a butyl group.

Preferably, M″ is a metal selected from Group 4, 5 or 10 of the Periodic Table. More preferably, M″ is V, Ti, Ni, Pd, Zr or Hf. Most preferably, M″ is Ti or Zr.

Preferably, Z is a halogen element selected from Group 17 of the Periodic Table. More preferably, Z is a chloride radical or a bromide radical.

Preferably, W and W′ are the same and independently a ligand compound having a cyclopentadienyl skeleton selected from the group consisting of cyclopentadienyl, indenyl and fluorenyl compounds. More preferably, W and W′ are the same and selected from a cyclopentadienyl and substituted cyclopentadienyl group. More preferably, W and W′ are the same and each is a cyclopentadienyl group.

Preferably, M and M′ are the same and each is selected from the group consisting of titanium (Ti), zirconium (Zr), hafnium (Hf), vanadium (V), niobium (Nb) and tantalum (Ta) elements. More preferably, M and M′ are the same and each is selected from the group consisting of zirconium, hafnium and titanium elements. Most preferably, M and M′ are the same and selected from Ti and Zr.

Even more preferably, M″, M and M′ are the same and selected from the group consisting of Zr, Hf and Ti; and more preferably, M″, M and M′ are the same and each is Ti or Zr.

Preferably, X and X′ are the same and each is selected from the group consisting of hydrogen, C₁₋₂₀ hydrocarbyl groups, halogen elements, C₁₋₂₀ alkoxy groups and C₁₋₂₀aryloxy groups. More preferably, X and X′ are the same and each is a halogen element. Most preferably, X and X′ are the same and each is a chloride or a bromide radical.

x depends on the valence of M and M′ and is preferably an integer from 0 to 3, more preferably 2 or 3.

z depends on the valence of M″ and is preferably an integer from 1 to 5, more preferably 2, 3 or 4.

The skilled person will understand that the catalyst compound of Formula 1 is a dinuclear or a trinuclear metallocene catalyst compound. Preferably the catalyst compound is a dinuclear metallocene catalyst compound.

A trinuclear metallocene catalyst compound as used herein means a metallocene-type compound having three active metal centres in its structure. The structure of said trinuclear metallocene catalyst compound is represented by Formula 1, wherein n=n′=1 (also illustrated in Formula 4).

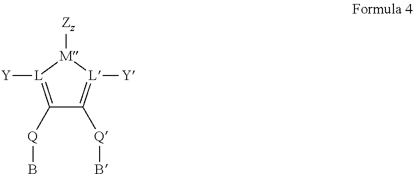

A dinuclear metallocene catalyst compound as used herein means a metallocene-type compound having two active metal centres in its structure and is represented by Formula 1, wherein n=1 and n′=0 or n=0 and n′=1. Said dinuclear metallocene catalyst compounds show high activity in olefin polymerisation and copolymerisation and the polyolefins produced in their presence show broad, bimodal molecular weight distribution and are obtained in high yields. In addition, these dinuclear metallocene catalyst compounds can be manufactured in a simple manner and at low cost, and the catalyst components are easier to separate and show very good stability during purification process.

The structure of such dinuclear metallocene catalyst compounds can be also represented by Formula 5a or 5b, wherein Z, M″, L, L′, Y, Y′, B and B′ are as defined herein above for Formula I and Q and Q′ are the same or different and independently selected from a C₁₋₃₀ alkyl group and a C₁₋₃₀ aryl group.

D and D′ are the same and each is hydrogen, a C₁₋₃₀ alkyl group or a C₁₋₃₀ aryl group. Preferably, D and D′ are selected from the group consisting of methyl, ethyl and phenyl. More preferably, D and D′ are a methyl group.

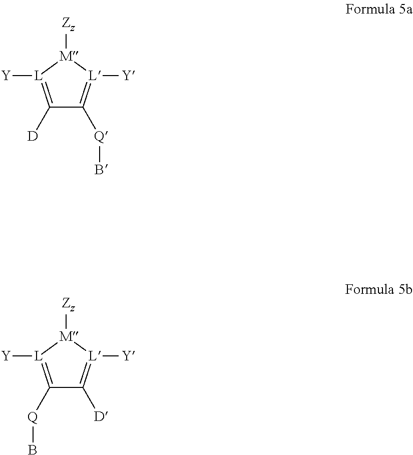

More preferably, the dinuclear metallocene catalyst compound comprises in its chemical structure an alpha-diimine moiety, with L and L′ being each a nitrogen atom as defined in Formula 1, which is coordinated to a late or early transition metal (that is M″ as defined in Formula 1) functionalised with a C₁₋₃₀ linear, branched or cyclic hydrocarbyl group or a C₁₋₃₀ aryl or substituted aryl group (that is Y and Y′ as defined in Formula 1) and then coupled by connecting one C₁₋₃₀ alkyl or aryl group (Q or Q′ as defined in Formula 1) with one half sandwich complex (B or B′ as defined in Formula 1). Such dinuclear metallocene catalyst compounds show broad, bimodal molecular weight distribution and are obtained in high yields.

An even more preferred example of the dinuclear metallocene catalyst compound is illustrated in Formula 6, wherein R is selected from the group consisting of methyl (Me), ethyl (Et) and isopropyl (i-Pr); most preferably, R is a methyl group; and M is selected from the group consisting of Ti, Hf and Zr elements; more preferably, M is Zr or Ti.

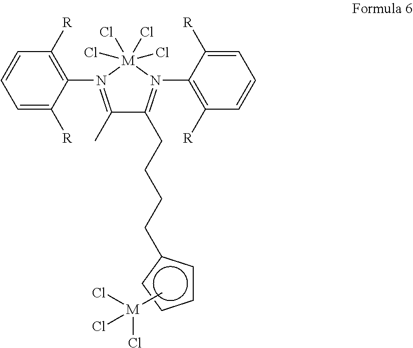

Particular examples of the most preferred dinuclear metallocene compounds according to the present invention are further illustrated in Formulas 7, 8, 9 and 10.

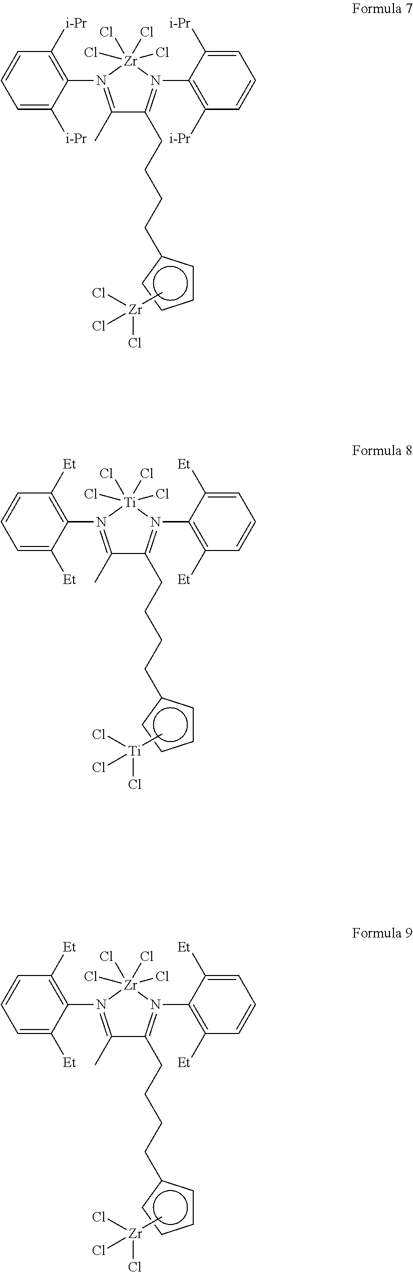

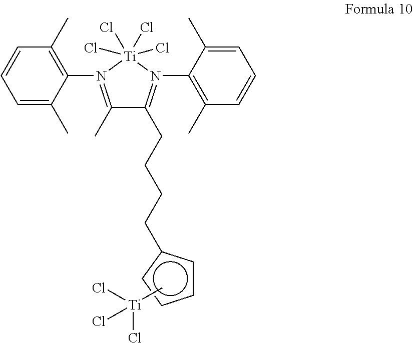

According to the present invention, the method to prepare a multinuclear metallocene catalyst compound comprises the steps of:
a) contacting a compound represented by Formula 1a with a compound selected from C₁₋₁₅ alkyl halide and C₁₋₃₀ aryl halide groups, in the presence of a strong base to give the compound of Formula 1b, 2b or 3b,

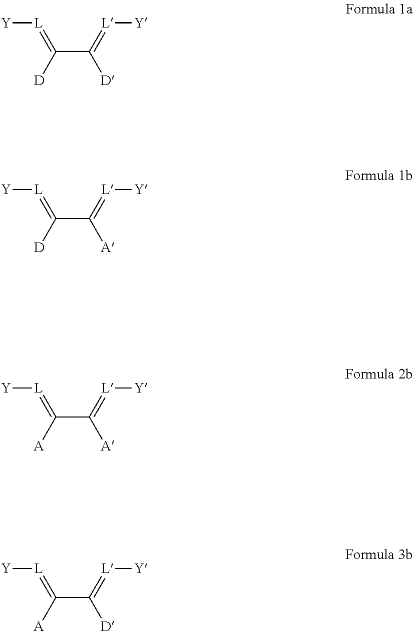

wherein:

Y and Y′ are the same or different and independently selected from the group consisting of a C₁₋₂₀ linear hydrocarbyl group, a C₁₋₂₀ branched hydrocarbyl group, a C₁₋₂₀ cyclic hydrocarbyl groups, C₁₋₃₀ aryl group and a C₁₋₃₀ substituted aryl groups;

L and L′ are the same or different and each is an electron-donating group independently selected from the elements of Group 15 of the Periodic Table;

D and D′ are the same and selected from the group consisting of hydrogen, C₁₋₃₀ alkyl, and C₁₋₃₀ aryl groups. Preferably D and D′ are the same and selected from the group consisting of hydrogen, C₁₋₁₅ alkyl, and C₁₋₃₀ aryl groups.

A and A′ are the same and selected from the group consisting of a C₁₋₁₅ alkyl halide and C₁₋₃₀ aryl halide group;
b) contacting the compound having the Formula 1b, 2b or 3b with at least one anionic ligand compound having a cyclopentadienyl skeleton selected from the group consisting of cyclopentadienyl, substituted cyclopentadienyl, indenyl, substituted indenyl, fluorenyl and substituted fluorenyl;
c) contacting the compound obtained in step b) with a strong base; and
d) contacting the compound obtained in step c) with at least two equivalents of a metal salt compound.

As skilled person will understand that it is possible that during the reaction a mixture of reaction products of Formula 1b, 2b and 3b is formed. The concentration of the reaction products may differ and be influenced for example by process conditions and the type and concentration of raw materials. If so needed a purification step may be carried out to isolate a particular reaction product.

The compound of Formula 1a can be prepared according to a known literature procedure (tom Dieck, H.; Svoboda, M.; Grieser, T. Z. Naturforsch. 1981, 36B, 823). According to the present invention, the compound having the structure illustrated in Formula 1a is contacted in step a) of the process with a C₁₋₁₅ alkyl halide or a C₁₋₃₀ aryl halide group in the presence of a strong base.

The strong base employed in step a) and step c) of the process according to the present invention can be the same or different and can be any basic chemical compound that is able to deprotonate the compound having the structure represented in Formula 1 a. Said base can have a pKₐ of at least 10; and preferably between 10 and 40, wherein pKₐ is a constant already known to the skilled person as the negative logarithm of the acid dissociation constant kₐ. Preferably, the strong base is a compound selected from the group consisting of alkyl lithium, alkyl amines, alkyl magnesium halides, sodium amide and sodium hydride and mixtures thereof. More preferably, the strong base is n-butyl lithium (BuLi) or a mixture of n-butyl lithium and tetramethylethylenediamine (TMEDA). Most preferably, the strong base in step a) is a mixture of BuLi and TMEDA; and in step c) is BuLi. The amount of the strong base used in each step may be between about 0.8 to about 1.2 mole of the strong base for each mole of hydrogen atom that is deprotonated. Preferably, the molar ratio between the strong base and hydrogen is between about 0.9:1 to about 1.15:1 and most preferably is between about 1:1 to about 1.1:1.

The compounds employed in step a) of the process according to the present invention may be contacted in any order or sequence. Preferably, the strong base is first reacted with the compound of Formula 1 a, followed by the addition of the alkyl halide or the aryl halide compound. This is to prevent a side reaction between the strong base and the alkyl halide or the aryl halide compound. The strong base may be added in step a) in any manner known in the art, such as dropwise, at a temperature of less than about 50° C., preferably less than about 0° C., more preferably less than about −70° C. but higher than about −100 ° C. The molar ratio between the strong base and the compound of Formula 1 a may be between about 3:1 to about 0.8:1, preferably between about 2.5:1 to about 0.9:1 and more preferably, between about 2:1 to about 1:1.

Preferably, A and A′ are the same and each is an alkyl halide group, in case of which the production of the isomers by-products is prevented. More preferably, A and A′ are the same and each is selected from the group consisting of 4-chlorobutyl, 3-chloropropyl, 5-bromopentyl, 4-bromobutyl and 3-bromopropyl groups. Most preferably, A and A′ are the same and each is a 4-bromobutyl or a 3-chloropropyl group.

The molar ratio between the alkyl halide or aryl halide employed in step a) and the compound of Formula la may be between about 4:1 to about 1:1, preferably between about 3:1 to about 1.5:1 and more preferably, between about 2.5:1 to about 2:1. The advantage of using excess of the alkyl halide or the aryl halide compound is to ensure the completion of the reaction.

The reactants employed in step a) may be contacted in the presence of any organic non-polar solvent known to the skilled person in the art. Preferred non-polar solvents are alkanes, such as isopentane, isohexane, n-hexane, n-heptane, octane, nonane, and decane, although a variety of other materials including cycloalkanes, such as cyclohexane, aromatics, e.g. benzene, toluene and ethylbenzene may also be employed. The most preferred solvent used is pentane. Prior to use, the solvent may be purified by using any conventional method, such as by percolation, through silica gel and/or molecular sieves in order to remove traces of water, polar compounds, oxygen and other compounds that can affect the catalyst activity. The reaction mixture may be stirred by using any type of conventional agitators for more than about 1 hour, preferably for more than about 8 hours and most preferably for more than about 10 hours but less than about 24 hours, at a temperature of from about 15 to about 30° C., preferably of from about 20 to about 25° C. The reaction mixture may be refluxed for more than about 10 hours, preferably for more than about 20 hours but less than about 40 hours and allowed to cool to room temperature, at a temperature of from about 15 to about 30° C., preferably of from about 20 to about 25° C. The solvent and any excess of components, such as the alkyl or the aryl halide may be removed by any method known in the art, such as evaporation.

The anionic ligand compound added in step b) of the process according to the present invention is preferably a cyclopentadienyl, a substituted cyclopentadienyl, an indenyl or a substituted indenyl group and more preferably, a cyclopentadienyl group. Said ligand compound is preferably a metalated compound, the metal being selected from the elements of Group 1 of the Periodic Table, more preferably the metal is lithium or sodium and most preferably the anionic ligand employed in step b) is lithium or sodium cyclopentadienide as high yield are obtained due to easier purification of the products.

The anionic ligand may be added in an amount of about 1.8 to about 1 mole of the anionic ligand for each mole of halogen atom that will be replaced. Preferably, the amount is about 1.6 to about 0.9 mole of the anionic ligand and more preferably about 1.4 to about 0.8 mole anionic ligand for each mole of halogen atom. The advantage of using excess of the anionic ligand is to ensure the completion of the reaction while the remained unreacted amount of the anionic ligand is easier to purify.

The anionic ligand compound may be added in the presence of an organic solvent, which may be selected from ethers and aromatic hydrocarbons. Preferably, ethers are used in step b) of the process according to the invention and more preferably, the solvent is tetrahydrofuran. The solvent may be added in an amount of about 30 to about 70 ml, preferably of about 40 ml to about 60 ml for each gram of the compound of Formula lb or 2b, at a temperature of more than about 25° C. and preferably, at a temperature that is 3° C. below the boiling point of the applied solvent. The contact time of the components in the reaction step b) may be more than 2 hours, preferably, more than 24 hours but less than 48 hours.

The product obtained in step b) of the process is represented by Formula 1c, Formula 2c or Formula 3c, wherein Y, Y′, L, L′, Q, Q′, D, W and W′ are as defined above.

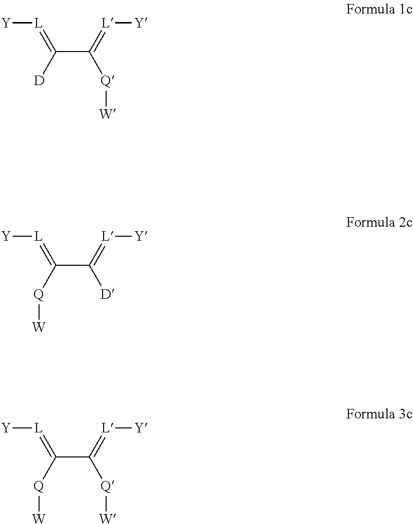

The strong base employed in step c) of the process according to the present invention may be added to the compound obtained in step b) in any conventional manner, such as dropwise, at a temperature of less than about 0° C., preferably less than about 50° C., more preferably less than about −70° C. but higher than about −100° C. The molar ratio between the strong base and the compound of Formula 1c or 2c or 3 c may be between about 3:1 to about 0.8:1, preferably between about 2.5:1 to about 0.9:1; and more preferably, between about 2:1 to about 1:1.

The reaction mixture may be stirred by using any type of conventional agitators at a temperature of from about 15 to about 30° C., preferably of from 20 to about 25° C. for more than about 1 hour and less than about 10 hours, preferably for about 5 to 7 hours.

The metal in the metal salt compound used in step d) may be selected from the group consisting of titanium, zirconium, hafnium, vanadium, niobium, and tantalum, more preferably from zirconium, hafnium and titanium. The anionic component or ligand in the metal salt may contain a halide, C₁-C₁₀ alkyl group, C₁-C₁₀ alkoxy group, C₁-C₂₀ aryl or aryloxy group. Preferably, the metal salt comprises at least one chloride or at least one bromide anion. More preferably, the metal salt is titanium tetrachloride or zirconium tetrachloride.

The molar ratio between the metal salt and the deprotonated compound produced in step c) may be between about 4:1 to about 1.7:1, preferably between about 3.5:1 to about 1.9:1 and more preferably, between about 3:1 to about 2:1.

The metal salt may be added to the reaction at a temperature of less than about 0° C., preferably less than about 50° C., more preferably less than about −70° C. but more than about −120° C., preferably more than about −100° C. The reaction mixture may be stirred by using any type of agitators generally employed in the art for a time of more than about 3 hour, preferably for more than about 20 hours and most preferably for more than about 30 hours but less than about 50 hours, at room temperature, that is at a temperature of from about 15 to about 30° C., preferably of from 20 to about 25° C.

Preferably, a compound of Formula 2b is contacted with three anionic ligand compounds in step b) and subsequently the compound obtained in step c) is further contacted with three equivalents of a metal salt compound in step d), in which case a trinuclear metallocene catalyst compound is obtained. More preferably, the compound having the Formula lb or 3b is contacted with two anionic ligand compounds in step b) and subsequently the compound obtained in step c) is further contacted with two equivalents of a metal salt compound in step d), in which case a dinuclear metallocene catalyst compound is obtained.

The catalyst system according to the present invention comprises said multinuclear metallocene catalyst precursor as defined herein and an activator. Activators, also known as co-catalysts, are well-known in the art and they often comprise a Group 13 atom, such as boron or aluminium. Examples of these activators are described by Y. Chen et al. (Chem. Rev., 2000, 100, 1397). Preferably, a borate, a borane or an alkylaluminoxane, such as methylaluminoxane (MAO) can be used as activators. When the activator is an aluminum compound such as, e.g., an alumoxane, the ratio of Al to M in the catalyst precursor compound usually is at least about 2:1, preferably at least about 10:1, most preferred at least about 60:1. Preferably the Al:M ratio is not higher than about 100000:1, more preferably not higher than about 10000:1, and most preferably not higher than about 2500:1.

The catalyst system of the present invention, may also comprise a scavenger. A scavenger is generally known as a compound that reacts with impurities present in the reaction medium, which are poisonous to the catalyst. Suitable scavengers can be hydrocarbyl of a metal or metalloid of Group 1-13 or its reaction products with at least one sterically hindered compound containing a Group 15 or 16 atom. Preferably, the Group 15 or 16 atom of the sterically hindered compound bears a proton. Examples of such sterically hindered compounds are tertbutanol, iso-propanol, triphenylcarbinol, 2,6-di-tert-butylphenol, 4-methyl-2,6-di-tertbutylphenol, 4-ethyl-2,6-di-tert-butylphenol, 2,6-di-tert-butylanilin, 4-methyl-2,6-di-tertbutylanilin, 4-ethyl-2,6-di-tert-butylanilin, HMDS (hexamethyldisilazane), diisopropylamine, di-tert-butylamine, diphenylamine and the like. Some examples of scavengers include butyllithium including its isomers, dihydrocarbylmagnesium, trihydrocarbylaluminium, such as trimethylaluminium, triethylaluminium, tripropylaluminium (including its isomers), tributylaluminium (including its isomers) tripentylaluminium (including its isomers), trihexylaluminium (including its isomers), triheptyl aluminium (including its isomers), trioctylaluminium (including its isomers), hydrocarbylaluminoxanes and hydrocarbylzinc and the like, and their reaction products with a sterically hindered compound or an acid, such as HF, HCl, HBr, HI. The molar ratio of the scavenger to the catalyst precursor is usually not higher than about 10000:1, preferably not higher than about 1000:1, and most preferred not higher than about 500:1. Excessive amount of scavenger decreases the activity of the catalyst and negatively affect some properties of the produced polymer, e.g. a polymer having lower molecular weight and high n-hexane extractable is produced.

One or more components of the catalyst system may be supported on an organic or inorganic support or may be preferably used without a support. Typically the support can be of any of the known solid, porous supports. Examples of support materials include talc; inorganic oxides such as silica, magnesium chloride, alumina, silica-alumina and the like; and polymeric supports such as polyethylene, polypropylene, polystyrene and the like. Preferred supports include silica, clay, talc, magnesium chloride and the like. Preferably the support is used in finely divided form. Prior to use the support is preferably partially or completely dehydrated. The dehydration may be done physically by calcining or by chemically converting all or part of the active hydroxyls. U.S. Pat. No. 4,808,561 discloses more details about support catalysts and catalyst components, respectively. If both the catalyst precursor and the cocatalyst are to be supported, the cocatalyst may be placed on the same support as the catalyst precursor or may be placed on a separate support. Also, the components of the catalyst system need not be fed into the reactor in the same manner. For example, one catalyst component may be slurried into the reactor on a support while the other catalyst component may be provided in a solution. The amount of the metal centres of the catalyst precursor is usually not higher than about 20 wt. %, preferably not higher than 10 wt. %, and most preferred not higher than 5 wt. %, based on the total amount of the support material. Excessive loading of central metals of catalyst on support causes uncontrollable increase in the temperature of the polymerization reaction and produces polymer having lower bulk density or lower molecular weight; in addition, shutting down the reactor becomes unavoidable.

The catalyst system according to the present invention as described herein is suitable for use in a solution, gas or slurry polymerization process or a combination thereof; most preferably, a gas or slurry phase process for oligomerisation, polymerisation and copolymerisation of olefins. Processes for polymerisation of olefins are generally known in the art. These processes are typically conducted by contacting at least one olefin with a catalyst system optionally comprising a scavenger in the gas phase or in the presence of an inert hydrocarbon solvent. Suitable solvents are C₅₋₁₂ hydrocarbons which may be substituted by a C₁₋₄ alkyl group, such as pentane, hexane, heptane, octane, isomers and mixtures thereof, cyclohexane, methylcyclohexane, pentamethyl heptane, and hydrogenated naphtha. The olefin polymerisation process according to the present invention may be conducted at temperatures of from 0° C. to about 350° C., depending on the product being made. Preferably, the temperature is from 15° C. to about 250° C. and most preferably, is from 20 ° C. to about 120° C. The polymerization pressure may be in the range from atmospheric pressure to about 400 bar, preferably from about 1 to about 100 bar. If desired, a chain transfer agent such as hydrogen may be introduced in order to adjust the molecular weight of the olefin polymer to be obtained. The amount of the catalyst used for polymerization may be in the range of from about 1×10⁻¹⁰ mol to about 1×10⁻¹ mol per liter of the polymerization volume, preferably in the range of from about 1×10⁻⁹ mol to about 1×10⁻⁴ mol. The term, “polymerization volume” as used herein means the volume of the liquid phase in the polymerization vessel in the case of the liquid phase polymerization or the volume of the gas phase in the polymerization vessel in the case of the gas phase polymerization. The time required for the polymerization reaction may be about 0.1 minute or more, preferably in the range of about one minute to about 100 minutes.

In the context of present invention, an olefinic monomer is understood to be a molecule containing at least one polymerisable double bond. Suitable olefinic monomers are C₂-C₂₀ olefins. Preferred monomers include ethylene and C₃₋₁₂ alpha-olefins which are substituted or unsubstituted by up to two C₁₋₆ alkyl radicals, C₈₋₁₂ vinyl aromatic monomers which are substituted or unsubstituted by up to two substituents selected from the group consisting of C₁₋₄ alkyl radicals and C₄₋₁₂ straight chained or cyclic hydrocarbyl radicals which are substituted or unsubstituted by a C₁₋₄alkyl radical. Illustrative non-limiting examples of such alpha-olefins are propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-nonadecene, 1-eicosene, 3-methyl-1-butene, 3-methyl-1-pentene, 3-ethyle-1-pentene, 4-methyl-1-pentene, 4-methyl-1-hexene, 4,4-dimethyl-1-hexene, 4,4-dimethyl-1-pentene, 4,4-ethyl-1-hexene, 3-ethyl-1-hexene, 9-methyl-1-decene. These olefins may be also used in combination. More preferably, ethylene and propylene are used. Most preferably the polyolefin is an ethylene homopolymer or copolymer. The amount of olefin used for the polymerization process may not be less than 20 mol % of the total components in the polymerization vessel, preferably not less than 50 mol %. The comonomer is preferably a C₃ to C₂₀ linear, branched or cyclic monomer, and in one embodiment is a C₃ to C₁₂ linear or branched alpha-olefin, preferably propylene, hexene, pentene, hexene, heptene, octene, nonene, decene, dodecene, 4-methyl-pentene-1, 3-methyl pentene-1, 3, 5, 5-trimethyl hexene-1, and the like. The amount of comonomer used for the copolymerization process may not be more than 50 wt. % of the used monomer, preferably not more than 30 wt. %.

The obtained polymer or resin may be formed into various articles, including bottles, drums, toys, household containers, utensils, film products, fuel tanks, pipes, geomembranes and liners. Various processes may be used to form these articles, including blow moulding, extrusion moulding, rotational moulding, thermoforming, cast moulding and the like. After polymerisation, conventional additives and modifiers can be added to the polymer to provide better processing during manufacturing and for desired properties of the desired product. Additives include surface modifiers, such as slip agents, antiblocks, tackifiers; antioxidants, such as primary and secondary antioxidants, pigments, processing aids such as waxes/oils and fluoroelastomers; and special additives such as fire retardants, antistatics, scavengers, absorbers, odor enhancers, and degradation agents. The additives may be present in the typically effective amounts well known in the art, such as 1×10⁻⁶ wt. % to 5 wt. %.

In yet another aspect, the polymer produced by the process of this invention may have a molecular weight distribution (Mw/Mn) of at least 15, preferably at least 30, more preferably at least 40, even more preferably at least 60, and most preferably of at least 70. Mw and Mn are measured by gel permeation chromatography (GPC) in 1,2,4-trichlorobenzene (flow rate 1 ml/min) at 150° C.

The invention will be elucidated by the following examples without being limited thereto.

### EXAMPLES

All experimental work was routinely carried out using Schlenk technique. Dried and purified argon was used as inert gas. n-Pentane, n-hexane, diethyl ether, toluene and tetrahydrofuran were purified by distillation over Na/K alloy. Diethyl ether was additionally distilled over lithium aluminum hydride. Methylene chloride was first dried with phosphorus pentoxide and then with calcium hydride. Methanol and ethanol were dried over molecular sieves. Deuterated solvents (CDCl₃, CD₂Cl₂) for NMR spectroscopy were purchased from Euriso-Top and stored over molecular sieves (3 A). Methylalumoxane (30% in toluene) was purchased from Crompton (Bergkamen) and Albemarle. Ethylene (3.0) and argon (4.8/5.0) were supplied by RieBner Company. All starting materials were commercially available and used without further purification.

NMR spectra were recorded with Bruker ARX (250 MHz), Varian Inova (300 MHz) and Varian Inova (400 MHz) spectrometers. The samples were prepared under inert atmosphere (argon) and recorded at 25° C. The chemical shifts in the ¹HNMR spectra are referred to the residual proton signal of the solvent (δ=7.24 ppm for CDCl₃, δ=5.32 ppm for CD₂Cl₂) and in ¹³C NMR spectra to the solvent signal (δ=77.0 ppm for CDCl₃, δ=53.5 ppm for CD₂Cl₂).

Mass spectra were recorded with a VARIAN MAT 8500 spectrometer (direct inlet, EI, E=70 eV).

GC/MS spectra were recorded with a FOCUS Thermo gas chromatograph in combination with a DSQ mass detector. A 30m HP-5 fused silica column (internal diameter 0.32 mm, film (d_{f}=0.25 μm), and flow 1 ml/min) was used and helium (4.6) was applied as carrier gas. The performed temperature program was started at 50° C. and was held at this temperature for 2 min. After a heating phase of twelve minutes (20° C. /min, final temperature was 290° C.), the end temperature was held for 30 min (plateau phase).

GPC measurements were performed using Waters Alliance GPC 2000 instrument. The polymer samples were dissolved in 1,2,4-trichlorobenzene (flow rate 1 ml/min) and measured at 150° C.

The elemental analysis was performed with a Vario EL III CHN instrument. 4-6 mg of a sample was weighed into a standard tin pan. The tin pan was carefully closed and introduced into the auto sampler of the instrument. The raw values of the carbon, hydrogen, and nitrogen contents were multiplied with calibration factors (calibration compound: acetamide).

Synthesis of the α-diimine compounds (compounds 1, 2 and 3; Scheme 1)

The α-diimine compounds 1, 2 and 3 were synthesized by condensation reactions according to Svoboda, M.; tom Dieck, H. (J. Organomet. Chem. 1980, 191, 321-328) and tom Dieck, H.; Svoboda, M.; Greiser, T. Z. (Naturforsch 1981, 36b, 823-832). Yields of the obtained compounds were: 1, 79%; 2, 85%; 3, 87% of the theoretical maximum yield. These compounds were characterized by GC-MS and NMR spectroscopy (Table 1).

Synthesis of the α-diimine compounds bearing chloropropyl groups (compounds 4, 5 and 6; Scheme 1)

A mixture of 6.6 ml (44 mmol) tetramethylethylenediamine (TMEDA) and 13.75 ml (22 mmol) n-butyllithium (1.6 M in n-hexane) was prepared in a pressure-equalizing dropping funnel containing 40 ml n-pentane. This mixture was added drop-wise to a stirred solution of 22 mmol α-diimine compound (compound 1, 2 or 3) in 100 ml of n-pentane at 0° C. When the addition was completed, the reaction mixture was left to warm up to about 21° C. and then stirred overnight. The next step was the addition of excess of 1-bromo-3-chloropropane (about 44 mmol, 4.36 ml) and refluxing the reaction mixture for 24 h. The refluxing was then stopped and the reaction mixture was allowed to cool down to room temperature (about 21° C.). Removal of the solvent and an excess of 1-bromo-3-chloropropane by evaporation resulted in a viscous yellow liquid which was dissolved in n-pentane and filtered over sodium sulphate. The solvent was removed and the resulting yellow thick liquid was purified by column chromatography on silica gel using n-hexane as eluant. The products were obtained as viscous yellow liquid after evaporating the solvents. Yields obtained: compound 4, 72%; compound 5, 77%; compound 6, 74% of the theoretical maximum yield. These compounds were characterized by GC/MS and NMR spectroscopy (Table 1).

Synthesis of the α-diimine compounds bearing cyclopentadienyl groups (compounds 7, 8 and 9; Scheme 2)

An amount of 3.52 g sodium cyclopentadienide (40 mmol) was added to 40 mmol α-diimine compound bearing a chlorobutyl group (compound 4, 5 or 6) in 100 ml THF. The reaction mixture was stirred at 60 ° C. for 36 h. The heating was stopped allowing the mixture to cool down to room temperature and the solvent was evaporated followed by the addition of n-pentane to the residue and filtering the resulting solution over sodium sulphate. The solvent was removed to afford the products as golden viscous liquids which were used in the next reactions without further purification. Yields obtained: compound 7, 75%; compound 8, 73%; compound 9, 82% of the theoretical maximum yield. These compounds were characterized by GC/MS and NMR spectroscopy (Table 1).

Synthesis of the dinuclear metallocene compounds (compounds 7a, 7b, 8a, 8b, 9a and 9b; Scheme 3)

5 mmol n-butyllithium (1.6 M in n-hexane) was drop-wise added to 5 mmol α-diimine compound bearing a cyclopentadienyl group (compound 7, 8 or 9) which was dissolved in 100 ml diethyl ether at −78 ° C. After warming up to room temperature, the mixture was stirred for 6 h. Subsequently, at −78 ° C., 10 mmol titanium tetrachloride or zirconium tetrachloride was added and the mixture was stirred for 36 h at room temperature (about 21 ° C.). Then, the solvent was evaporated and the residue was extracted with dichloromethane and the solution was filtered over sodium sulfate. The solution was reduced in volume and the products were precipitated by adding n-pentane. The yields obtained were: compound 7a, 79%; compound 7b, 75%; compound 8a, 72%; compound 8b, 70%; compound 9a, 85%. compound 9b, 81% of the theoretical maximum yield. The compounds 7a, 7b, 8a, 8b, 9a and 9b as obtained were characterized by MS and elemental analysis (Table 2).

Activation of the complexes

5 mg of each of the compounds 7a, 7b, 8a, 8b, 9a and 9b was suspended in 5 ml toluene. Methylalumoxane (30% in toluene, M:Al=1:1500) was added resulting in an immediate colour change. The mixture was added to a 1 1 Schlenk flask filled with 250 ml n-pentane.

### Polymerization of Ethylene

The mixture in n-pentane was transferred to a 1 1 Büchi laboratory autoclave under inert atmosphere and thermostated at 65° C. An ethylene pressure of 10 bar was applied for 1 h. After releasing the pressure, the polymer was filtered over a frit, washed with diluted hydrochloric acid, water, and acetone, and finally dried in vacuo. Samples of the produced polyethylene were analyzed by GPC (Table 3).

### Comparative Experiments

The half sandwich complexes, cyclopentadienyltitanium trichloride A in an amount of 5 mg and cyclopentadienylzirconium trichloride B in an amount of 5 mg were activated with methylaluminoxane (MAO); the M:Al ratio was 1:1500. The activated complexes were tested for the polymerization of ethylene using the same polymerization conditions as applied to the dinuclear catalyst compounds 7a, 7b, 8a, 8b, 9a and 9b. The results are presented in Table 3.

The GPC results of polyethylenes produced with the dinuclear catalysts displayed broader molecular weight distributions than the mononuclear catalysts (see Table 1 and Schemes 4 and 5).

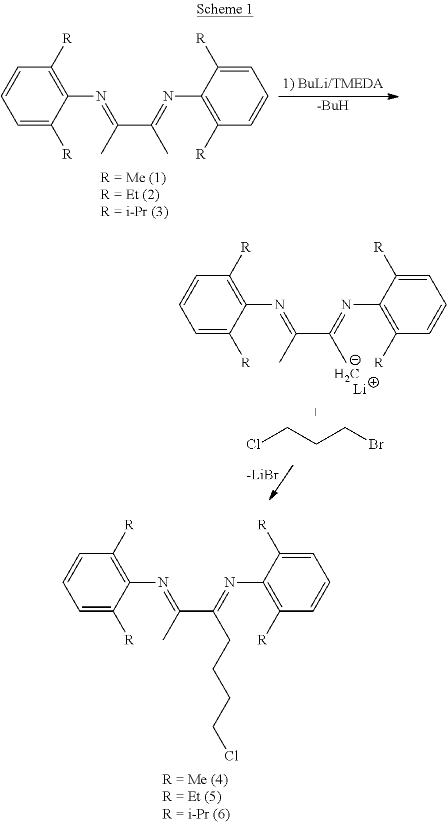

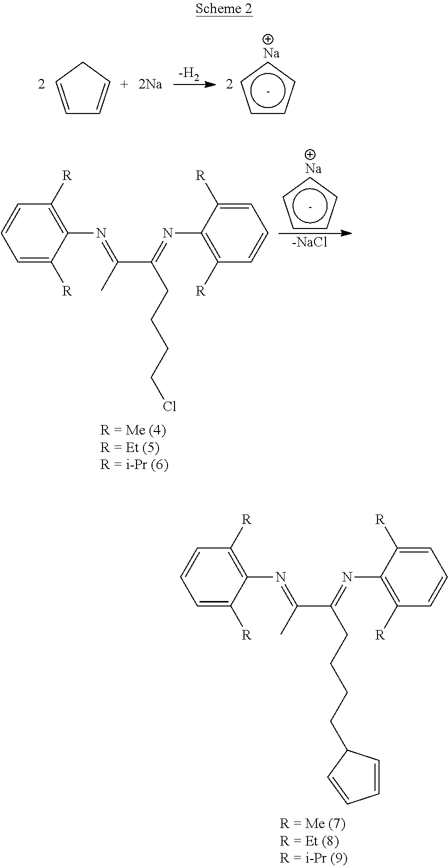

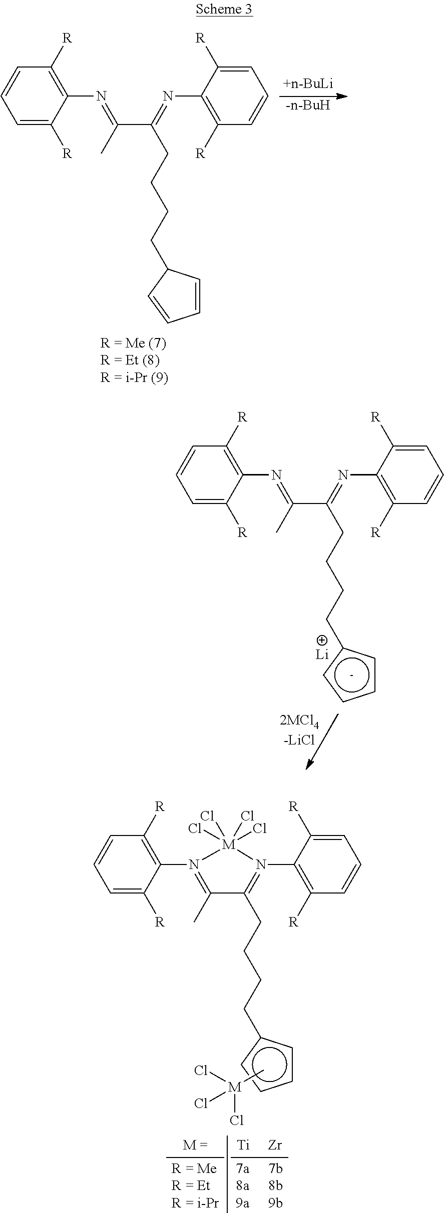

TABLE 1

| Comp. | | | |
|---|---|---|---|
| Nr. | Mass spectra [m/z(%)] | ¹H-NMR [ppm]^{a)} | ¹³C-NMR [ppm]^{b)} |
| 1 | 292(M^{.+}), 277(24), 172(1), | 7.5(d, 4H), 6.92(t, 2H), | Cq: 168, 148.3, 124.6 |
| | 146(100), 105(30) | 2.02(s, 12H), 1.98(s, 6H). | CH: 127.9, 123.2 |
| | | | CH₃: 17.8, 15.8 |
| 2 | 348(M^{.+}), 333(1), 319(91), | 7.1(d, 4H), 7.04(t, 2H), | Cq: 168, 147.5, 130.5 |
| | 200(1), 174(100), 105(30) | 2.37(m, 8H), 2.05(s, 6H), | CH: 126.1, 123.5 |
| | | 1.15(dd, 12H). | CH₂: 24.7 |
| | | | CH₃: 16.2, 13.6 |
| 3 | 404(M^{.+}, 0.8), 361(70), | 7.20(d, 4H), 7.13(t, 2H), | Cq: 168, 146, 135 |
| | 212(1), 202(100), 160(23) | 2.75(sep, 4H), 2.10(s, 6H), | CH: 123.8, 123, 28.5 |
| | | 1.22(d, 12H), 1.18(d, 12H). | CH₃: 22.8, 16.8 |
| 4 | 368(M^{.+}, 1) 353(36), | 7.06(d, 4H), 6.94(t, 2H), | Cq: 170.8, 167.5, 148.4, 147.8, |
| | 317(100), 222(67), | 3.38(t, 2H), 2.52(t, 2H), | 124.6 |
| | 146(94), 105(50) | 2 .04(s, 6H), 2.02(s, 6H), | CH: 128.5, 128, 123.3, 123.3 |
| | | 2.01(s, 3H), 1.64(m, 4H). | CH₂: 44.4, 32.7, 28.3, 24.2 |
| | | | CH₃: 18, 16.3 |
| 5 | 424(M^{.+}), 395(2), 388(26), | 7.1(d, 4H), 7.02(t, 2H), | Cq: 170.4, 167.7, 147.4, 146.9, |
| | 359(100), 306(18), | 3.37(t, 2H), 2.52(t, 2H), | 130.6, 130.3 |
| | 214(94), 174(64), 105(20) | 2.36(m, 8H), 2.03(s, 3H), | CH: 126.1, 125.9, 123.6, 123.5 |
| | | 1.65(m, 4H), 1.18(t, 6H) | CH₂: 44.4, 32.8, 28.6, 24.8, 24 |
| | | 1.13(t, 6H). | CH₃: 16.7, 13.9, 13.4 |
| 6 | 480(M^{.+}, 1), 444(12), | 7.20-7.14(m, 4H), | Cq: 170.5, 168, 146.1, 145.6, |
| | 437(36), 429(9), 401(91), | 7.11(t, 2H), 3.41(t, 2H), | 135.2, 134.9 |
| | 359(18), 278(87), 242(75), | 2.72(sep, 4H), 2.55(t, 2H), | CH: 123.8, 123.7, 123, 122.8, |
| | 202(100), 160(26) | 2.07(s, 3H), 1.68(m, 4H), | 28.5 |
| | | 1.25(d, 6H), 1.22(d, 6H), | CH₂: 44.6, 32.9, 28.9, 23.9 |
| | | 1.19(d, 6H), 1.14(d, 6H). | CH₃: 23.2, 22.7, 22.2, 22.1, 17.1 |
| 7 | 398(M^{.+}, 28), 383(32), | 7.05(d, 4H), 6.92(t, 2H), | Cq: 171.5, 167.5, 148.5, 148, |
| | 293(8), 252(100), 236(6), | 6.34(m, 1H), 6.18(m, 1H), | 124.7, 124.6 |
| | 146(64), 105(58) | 5.98(m, 1H), 5.83(m, 1H), | CH:134.6, 133.6, 132.3, 130.4, |
| | | 2.86(m, 1H), 2.52(t, 2H), | 128, 123.2, 44.7 |
| | | 2.23(q, 2H), 2.03(s, 3H), | CH₂: 43.1, 41.2, 29.3, 26.4 |
| | | 2.01(s, 6H), 2.00(s, 6H), | CH₃: 18, 16.3 |
| | | 1.46(m, 4H). | |
| 8 | 454(M^{.+}, 12), 425(100), | 7.10(d, 4H), 7.01(t, 2H), | Cq: 171.2, 167.7, 147.5, 147, |
| | 349(3), 280(53), 250(4), | 6.34(m, 1H), 6.18(m, 1H), | 130.6, 130.4 |
| | 174(42), 105(39) | 5.98(m, 1H), 5.84(m, 1H), | CH: 134.6, 133.6, 132.3, |
| | | 2.86(m, 1H), 2.52(t, 2H), | 130.4, 126.1, 125.8, 123.5, 123.4, |
| | | 2.35(q, 8H), 2.22(q, 2H), | 44.7 |
| | | 2.02(s, 3H), 1.46(m, 4H), | CH₂: 43.1, 41.2, 29.4, 26.3, 24.8, |
| | | 1.16(t, 6H), 1.13(t, 6H). | 24.7 |
| | | | CH₃: 16.8, 13.8, 13.4 |

^{a)}25° C. in chloroform-d₁, rel. CHCl₃, δ = 7.24 ppm
^{b)}25° C. in chloroform-d₁, rel. CHCl₃, δ = 77.0 ppm
Cq = quaternary carbon

TABLE 2

| | Mass spectra | Elemental analysis |
|---|---|---|
| Nr. | [m/z(%)] | [%] |
| 7a | 738(M^{.+}, 7), 706(5), 588(5), 551(6), 486(14), | Measured: C, 45.39; H, 4.47; N, 4.10 |
| | 424(15), 316(10), 216(18), 188(48), 158(37), | Calculated: C, 45.36; H, 4.49; N, 3.78 |
| | 146(100), 120(49), 105(93) | |
| 7b | 827(M^{.+}, 3), 792(9), 721(7), 632(8), 597(4), | Measured: C, 40.45; H, 4.01; N, 3.63 |
| | 484(12), 442(9), 386(5), 345(7), 290(8), | Calculated: C, 40.61; H, 4.02; N, 3.38 |
| | 214(16), 146(63), 121(100), 106(97) | |
| 8a | 796(M^{.+}), 761(12), 741(2), 710(4), 643(10), | Measured: C, 46.95; H, 5.01; N, 3.61 |
| | 606(6), 455(15), 434(7), 362(9), 308(10), | Calculated: C, 48.19; H, 5.18; N, 3.51 |
| | 250(9), 216(15), 174(11), 134(24) | |
| 8b | 879(M^{.+}, 4), 845(3), 809(8), 774(5), 763(7), | Measured: C, 42.53; H, 5.13; N, 3.16 |
| | 736(12), 689(4), 469(8), 454(20), 411(6), | Calculated: C, 43.46; H, 4.67; N, 3.17 |
| | 359(17), 280(7), 242(10), 174(53), 149(63), | |
| | 134(100), 120(35) | |
| 9a | 854(M^{.+}), 825(7), 784(4), 765(3), 748(7), | Measured: C, 48.54; H, 6.07; N, 3.35 |
| | 734(6), 697(7), 512(15), 462(19), 390(20), | Calculated: C, 50.65; H, 5.79; N, 3.28 |
| | 244(24), 202(100), 162(100), 144(33), | |
| | 120(39) | |
| 9b | 938(M^{.+}, 9), 902(5), 810(8), 739(13), 688(10), | Measured: C, 44.31; H, 5.28; N, 2.76 |
| | 510(7), 407(14), 308(12), 244(17), 202(100), | Calculated: C, 45.98; H, 5.25; N, 2.98 |
| | 187(26), 162(55), 132(27), 120(52) | |

TABLE 3

| | Activity | Mw | Mn | |
|---|---|---|---|---|
| Example | (kg PE/mol cat. h) | (g/mol) | (g/mol) | MWD |
| 7a | 5365 | 148100 | 5361 | 27.62 |
| 7b | 5922 | 172914 | 4800 | 36.02 |
| 8a | 4360 | 396920 | 23657 | 16.78 |
| 8b | 5275 | 407573 | 8026 | 50.78 |
| 9a | 4025 | 535960 | 18720 | 28.63 |
| 9b | 4298 | 479811 | 13550 | 35.41 |
| A | 6750 | 345628 | 102821 | 3.36 |
| B | 8130 | 429880 | 121921 | 3.53 |

1. A multinuclear metallocene catalyst compound according to Formula 1: 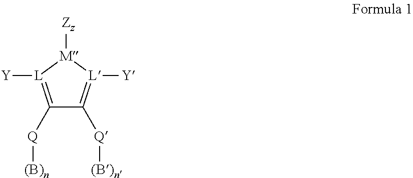
wherein:
Y and Y′ are the same or different and independently selected from a C₁₋₂₀ linear hydrocarbyl group; C₁₋₂₀branched hydrocarbyl group; C₁₋₂₀ cyclic hydrocarbyl group; a C₁₋₃₀ aryl group and a C₁₋₃₀ substituted aryl group;
L and L′ are the same or different and each is an electron-donating group independently selected from the elements of Group 15 of the Periodic Table;
Q and Q′ are the same or different and independently selected from hydrogen, a C₁₋₃₀ alkyl group and a C₁₋₃₀ aryl group;
M″ is a metal selected from Group 3, 4, 5, 6, 7, 8, 9 and 10 elements and from lanthanide series elements of the Periodic Table;
Z is selected from the group consisting of hydrogen; a halogen element; a C₁₋₂₀ hydrocarbyl group; C₁₋₂₀alkoxy group and a C₁₋₂₀aryloxy group;
B and B′ are the same or different and each is a half sandwich metallocene compound, with B being represented by Formula 2 and B′ being represented by Formula 3:
W-M-X (Formula 2)
W′-M′-X′_{x′} (Formula 3)
wherein:
W and W′ are the same or different and independently a ligand compound having a cyclopentadienyl skeleton selected from the group consisting of cyclopentadienyl, substituted cyclopentadienyl, indenyl, substituted indenyl, fluorenyl and substituted fluorenyl;
M and M′ are the same and each is independently selected from the group consisting of scandium; yttrium; lanthanoid series elements; titanium; zirconium; hafnium; vanadium;
niobium; and tantalum;
X and X′ are the same or different and each is selected from the group consisting of hydrogen; a halogen element; a C₁₋₂₀ hydrocarbyl group, C₁₋₂₀ alkoxy group; and C₁₋₂₀ aryloxy group;
x and x′ are independently integers from 0 to 3;
z is an integer from 1 to 5;
n, n′ are independently 0 or 1, with 1<(n+n')<2.

2. The catalyst compound according to claim 1, wherein n=1 and n′=0 or n=0 and n′=1 and having the structure represented in Formula 5a or 5b, 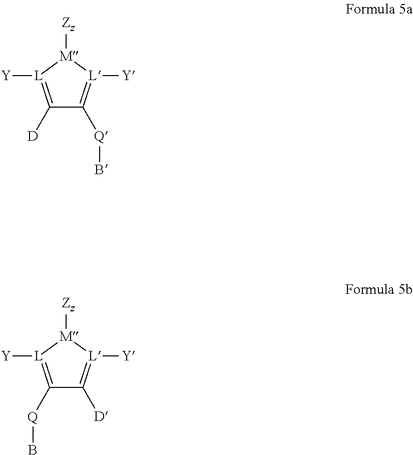
wherein D and D′ are the same and each is hydrogen, a C₁₋₃₀ alkyl group or a C₁₋₃₀ aryl group.

3. The catalyst compound according to claim 2, wherein D and D′ are selected from the group consisting of methyl, ethyl and phenyl.

4. The catalyst compound according to claim 1, wherein L and L′ are each a nitrogen atom; Y and Y′ are the same and selected from C₁₋₃₀ aryl and C₁₋₃₀ substituted aryl groups; Q and Q′ are the same and selected from C₁₋₃₀ alkyl groups; M″ is Ti or Zr; Z is a chloride radical or a bromide radical; W and W′ are the same and selected from cyclopentadienyl and substituted cyclopentadienyl groups; M and M′ are the same and selected from Ti and Zr; X and X′ are the same and each a halogen element; x is 2 or 3; and z is 2, 3 or 4.

5. The catalyst compound according to claim 1, wherein n =n′=1.

6. A method to prepare a multinuclear metallocene catalyst compound according to claim 1, which comprises:
a) contacting a compound represented by Formula la with a compound selected from C₁₋₁₅ alkyl halide and C₁₋₃₀ aryl halide groups, in the presence of a strong base to give the compound of Formula 1b, 2b or 3b, 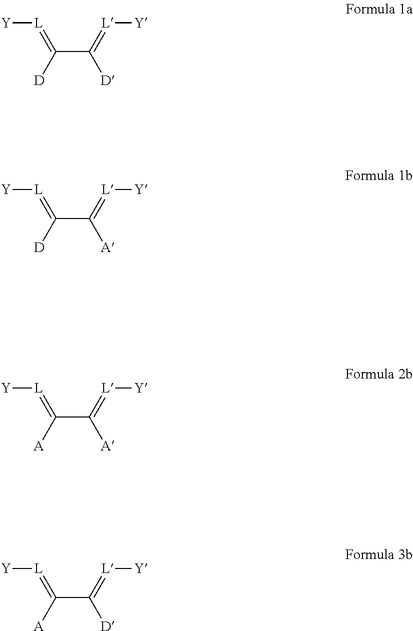
wherein:
Y and Y′ are the same or different and independently selected from the group consisting of a C₁₋₂₀ linear hydrocarbyl group, a C₁₋₂₀ branched hydrocarbyl group, a C₁₋₂₀ cyclic hydrocarbyl groups, C₁₋₃₀ aryl group and a C₁₋₃₀ substituted aryl groups;
L and L′ are the same or different and each is an electron-donating group independently selected from the elements of Group 15 of the Periodic Table;
D and D′ are the same and selected from the group consisting of hydrogen, C₁₋₃₀ alkyl group or a C₁₋₃₀ aryl group;
A and A′ are the same and selected from the group consisting of a C₁₋₁₅ alkyl halide and C₁₋₃₀ aryl halide group;
b) contacting the compound having the Formula 1b, 2b or 3b with at least one anionic ligand compound having a cyclopentadienyl skeleton selected from the group consisting of cyclopentadienyl, substituted cyclopentadienyl, indenyl, substituted indenyl, fluorenyl and substituted fluorenyl compounds;
c) contacting the compound obtained in step b) with a strong base; and
d) contacting the compound obtained in step c) with at least two equivalents of a metal salt compound.

7. The process according to claim 6, wherein the strong base in step a) is a mixture of n-butyl lithium and tetramethylethylenediamine and the strong base in step c) is n-butyl lithium.

8. The process according to claim 6, wherein the compound having the Formula 2b is contacted with three anionic ligand compounds in step b) and further the compound obtained in step c) is contacted with three equivalents of a metal salt compound in step d).

9. The process according to claim 6, wherein the compound having the Formula lb or 3b is contacted with two anionic ligand compounds in step b) and subsequently the compound obtained in step c) is contacted with two equivalents of a metal salt compound in step d).

10. The process according to claim 6, wherein the metal salt is titanium tetrachloride or zirconium tetrachloride.

11. The process according to claim 6, wherein the anionic ligand is lithium cyclopentadiene or sodium cyclopentadiene.

12. A catalyst system comprising the multinuclear metallocene catalyst compound according to claim 1 and a co-catalyst.

13. A process for the polymerisation of olefins comprising contacting said olefins with the catalyst system according to claim 12 under reaction conditions effective for forming a polyolefin.

14. The process according to claim 13, wherein the olefin is an alpha-olefin.

15. The process according to claim 14, wherein the olefin is ethylene.
